(19) United States
(12) Patent Application Publication
(10) Pub. No.: US 2022/0108624 A1
(43) Pub. Date: Apr. 7, 2022

(54) READER ASSISTANCE METHOD AND SYSTEM FOR COMPREHENSION CHECKS

(71) Applicant: INTERNATIONAL BUSINESS MACHINES CORPORATION, Armonk, NY (US)

(72) Inventors: Shikhar Kwatra, Raleigh, NC (US); Komminist Weldemariam, Ottawa (CA); Adam Lee Griffin, Dubuque, IA (US); Zachary A. Silverstein, Jacksonville, FL (US); Itzhack Goldberg, Hadera (IL)

(21) Appl. No.: 16/948,852

(22) Filed: Oct. 2, 2020

(51) Int. Cl. G09B 19/00; G06F 40/263; G06F 40/242; G06F 40/247; G06K 9/00; G06K 9/46; G06F 3/16; G06T 11/00; G06F 40/58; G09B 5/06; G09B 19/06

(52) U.S. Cl. CPC G09B 19/00; G06F 40/263; G06F 40/242; G06F 40/247; G06K 9/00718; G06K 9/46; G06K 2209/01; G06K 9/00335; G06F 3/165; G06T 11/00; G06F 40/58; G09B 5/065; G09B 19/06; G06K 9/00221

(57) ABSTRACT

A method for providing a selective translation of a word when the user is utilizing an augmented reality device. Receiving data from an augment device, wherein the data at least includes a first video of where the augmented device is pointed, wherein the first video at least includes images of a text a user is reading, wherein the data further includes a second video of the user face as the user is reading the text. Evaluating the data to determine that the user is having a comprehension issue with a word on the text and retrieving, the definition of the word, synonyms of the word, antonyms of the word, and the pronunciation of the word that is causing the comprehension issue. Conveying the definition of the word, synonyms of the word, antonyms of the word, and the pronunciation of the word that is causing the comprehension issue to the user.

### BACKGROUND

The present invention relates generally to the field of augmented reality devices, and more particularly to selectively translating parts of a text a user is viewing with the augmented reality device, when the user has a comprehension issue with the text.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for providing a selective translation of a word when the user is utilizing an augmented reality device to read text. Receiving data from an augment device, wherein the data at least includes a first video of where the augmented device is pointed, wherein the first video at least includes images of a text a user is reading, wherein the data further includes a second video of the user face as the user is reading the text. Evaluating the data to determine that the user is having a comprehension issue with a word on the text and retrieving, the definition of the word, synonyms of the word, antonyms of the word, and the pronunciation of the word that is causing the comprehension issue. Conveying the definition of the word, synonyms of the word, antonyms of the word, and the pronunciation of the word that is causing the comprehension issue to the user.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating an augmented reality processing environment, in accordance with an embodiment of the present invention.

FIG. 2 is a flowchart depicting operational steps of the augmented reality processing environment of FIG. 1, in accordance with an embodiment of the present invention.

FIG. 3 is a block diagram of components of a computing device of the augmented processing environment of FIG. 1, in accordance with embodiments of the present invention.

FIG. 4 depicts a cloud computing environment according to an embodiment of the present invention.

FIG. 5 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for an augmented reality system that acts as selective translator for the user when the user demonstrates a comprehension issue with a text. Every individual has her own unique vocabulary and command of a language or languages. Yet, if one stumbles on a new word or phrase which one wants to learn, one must turn to a “one size fits all” dictionary or translator. Too often, one finds that the dictionary or translator uses synonyms or phrases, which are also not clear to the user and as such require further drill down.

The present invention allows for a custom/tailor made translator/dictionary to be used that provides the user with the needed information to solve the user comprehension issue. The crux of the idea is that user would utilize an augmented reality device whenever the user reads books, text, or documents. The user indicates that he is having a comprehension issue with a portion of the text the user is reading based on how the user interacts with the augmented reality device. The system stores the user interactions with the augmented device to build a user profile to better determine when the user needs explanation of new unknown (to him) words. In doing so, the system can build a tailored made dictionary for the user be it for one language or more.

The system detects comprehension cues from a user gestures, posture, and facial expressions, by using read-assist systems. The user can take advantage of the embedded system in the augmented reality device in any reading context (e.g., in a store, on a street, etc.). This allows for the user to work on their comprehension of a language in a real-world learning environment. For learning a foreign language, the device may work to assist user comprehension in the real world of written text, signs, menus, etc.

The system learns to recognize the user gestures such as turning a page, scrolling on a touchpad, pointing a finger at a word, as well as postural adjustments by analyzing data collected from accelerometers, bio-signals, and cameras located in the augmented reality device. Additionally, the system uses a camera to monitor facial expressions to detect that the user might have a comprehension issue with the text he is currently reading. Comprehension assessment is performed in the context of text analysis and comparison of current text to a stored user lexicon. When the system detects that the user is having a comprehension issue, then the device interrupts the user's reading and provides remedial instruction on the most likely points of lack of comprehension by utilizing a display or audio device to provide the remedial instructions.

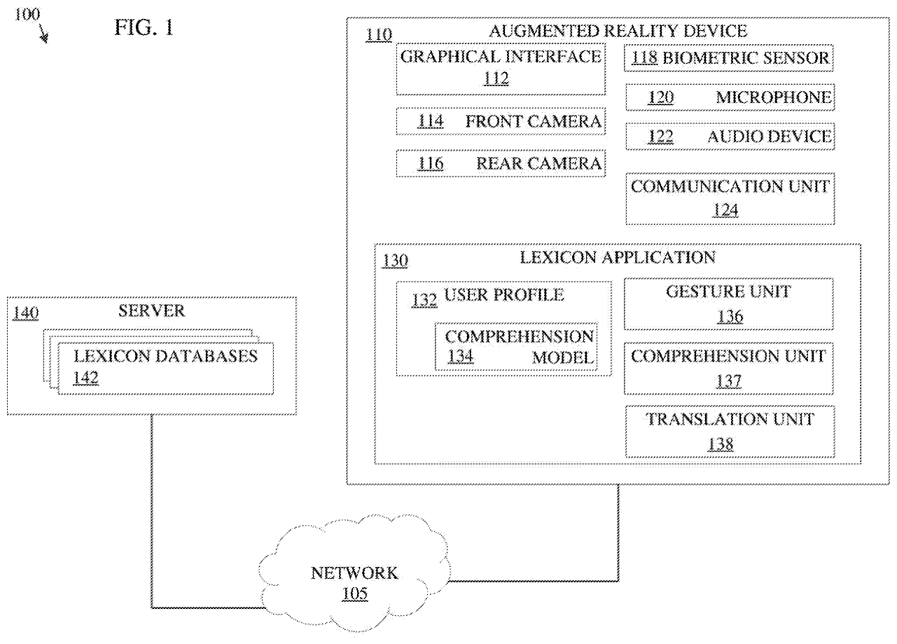

FIG. 1 is a functional block diagram illustrating an augmented reality processing environment 100, in accordance with an embodiment of the present invention.

Network 105 can be, for example, a local area network (LAN), a wide area network (WAN) such as the Internet, or a combination of the two, and can include wired, wireless, or fiber optic connections. In general, 105 110 can be any combination of connections and protocols that will support communications between augmented reality device 110 and server 140.

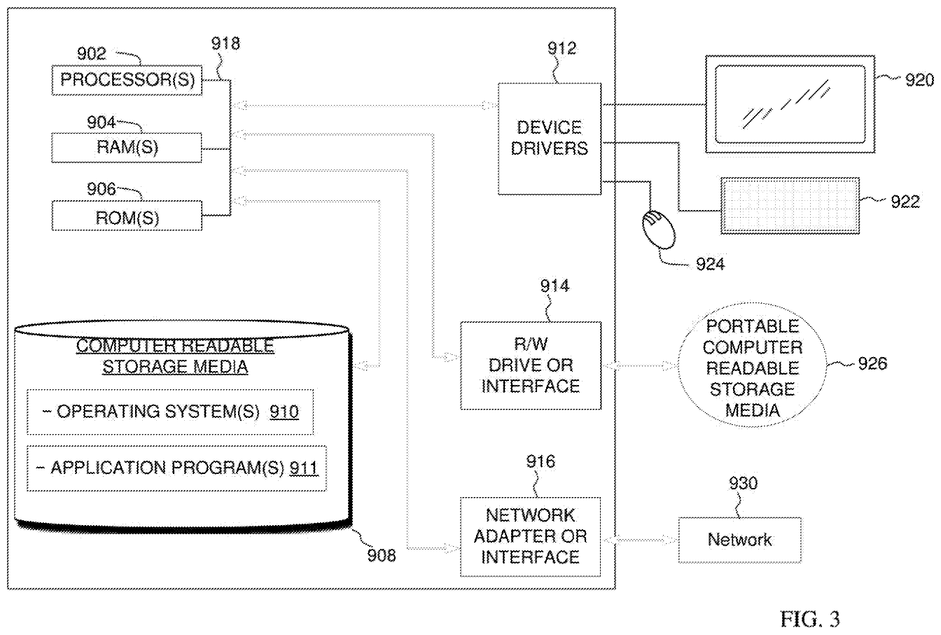

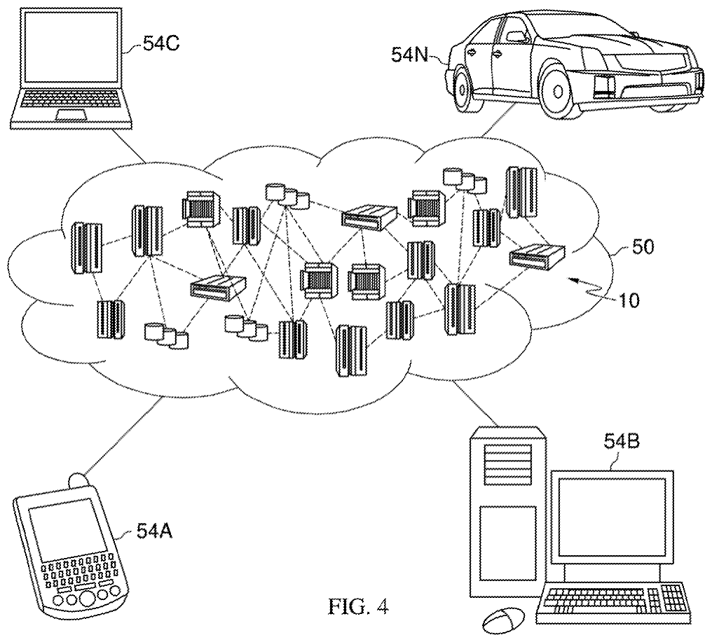

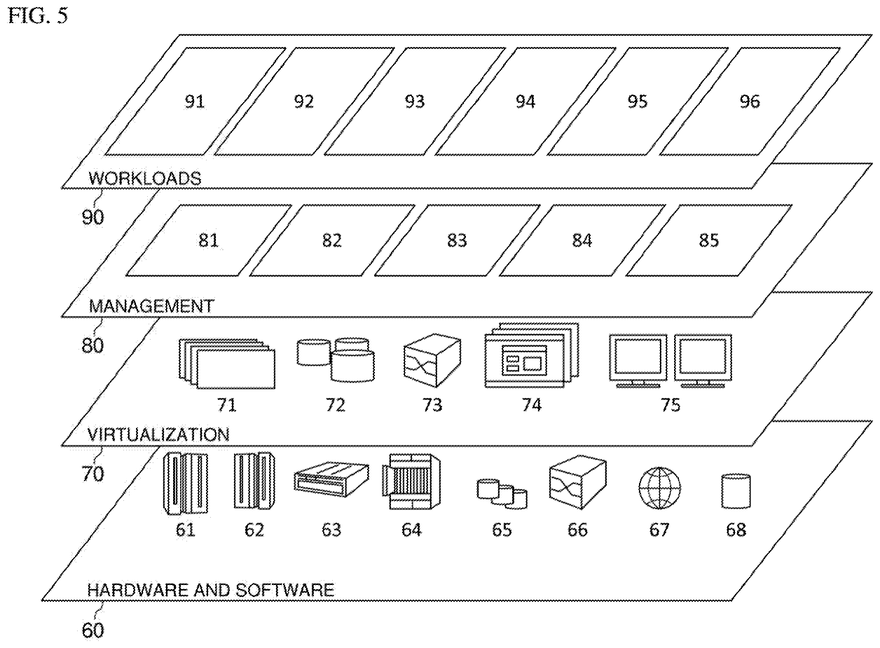

Augmented reality device 110 may be a laptop computer, tablet computer, netbook computer, personal computer (PC), a desktop computer, a personal digital assistant (PDA), a smart phone, augment reality glasses, or any augmented reality device capable of communicating with server 140 via network 105 and with various components and devices within enterprise grid 112. In other embodiments, augmented reality device 110 may include internal and external hardware components, as depicted, and described in further detail below with respect to FIG. 3, and operate in a cloud computing environment, as depicted in FIGS. 4 and 5.

The augmented reality device 110 can include a graphical interface 112, a front camera 114, a rear camera 116, a biometric sensor 118, a microphone 120, an audio device 122, a communications unit 124, and a lexicon application 130. The graphical interface 112 is a display that shows images taken from the front camera 114 and messages from lexicon application 130. The front camera 114 is a camera that can take video images in the direction the augmented device 110 is pointed. For example, the front camera 114 captures video of the text the user is currently reading and displays the text on the graphical interface 112. The front camera 114 further catches any gestures the user makes in the field of view of the front camera 114. For example, if the user points at a word in the text, then the front camera 114 captures the user hand movement and the word the user is pointing at.

The rear camera 116 captures video data of the user, specially, the rear camera 116 captures video of the user's face. The video of the user's face allows for the facial expressions and the eye movements of the user to be captured. The biometric sensor 118 can be include in the augmented device 1120 but the biometric sensor 118 is not necessary. The biometric sensor 118 collects biometric data from the user, for example, the biometric sensor 118 can detect heart rate, blood pressure, etc. The microphone 120 detects any audio sounds the user makes. The microphone 120 picks up the user generated audio, for example, if the user is reading the text out loud or states a question about the text. The microphone 120 picks up audio when the user stumbles, stutters, or hesitates over a word in the text.

The audio device 122 can be a speaker that is integral with the augmented device 110. Alternatively, the audio device 122 can be a separate device, for example, a speaker, headphones, or other audio capable device that can connect to the augmented device 110 through a wired or wireless connection. The communications unit 124 allows for the augmented device 110 to transmit and receive data.

FIG. 1 illustrates the lexicon application 130 as being installed on the augmented device 110. This illustration is not meant to be limiting, the lexicon application 130 can have some components installed on augmented device while have other components installed on a server elsewhere. The lexicon application 130 can include a user profile 132, a gesture unit 136, a comprehension unit 137, and a translation unit 138. The lexicon application 130 receives data from the front camera 114, the rear camera 116, the biometric sensor 118, and the microphone 120.

The user profile 132 includes data collected about the user, for example, user gestures, body language, eye movement, or other information collected about the user to help determine when the user is having a comprehension issue with the text they are reading. The user profile 132 includes a comprehension model 134 that contains information about the user literacy/language skills (e.g., vocabulary progression level), engagement model (e.g., learned from historical user interactions), preference/style, etc.

The gesture unit 136 recognizes gestures the user makes in the field of view of the front camera 114. The user profile 132 stores prior learned gestures that the user utilized and what those stored gestures were trying to convey. The gesture unit 136 receives the video data from the front camera 114 and determines if the user makes any gestures in the video. When the gesture unit 136 determines that the video contains a gesture, then the gesture unit 136 determines if the gesture is a known gesture or not. The gesture unit 136 determines if the gesture is known by matching the gesture to a previously identified gesture stored in the user profile 134. When the gesture is an unknown gesture, (i.e. a new gesture), then gesture unit 136 tries to determine what the user is trying to convey with the gesture. When the gesture unit 136 determines what the gesture means, then the gesture unit 136 stores the gesture in the user profile 134 with it meaning.

The comprehension unit 137 determines if the user comprehends what he is currently reading. One way for the user to indicate that he does not comprehend the text is for the user to use a gesture to actively show his lack of comprehension. When the comprehension unit 137 receives indication from the gesture unit 136 that the user does not comprehend a word, then comprehension unit 137 identifies the word that is causing the user comprehension issue. The comprehension unit 137 transmit the identified word to the translation unit 138.

The comprehension unit 137 can further determine that user is having a comprehension issue based on data received from the rear camera 116, biometric sensors 118 (if available), and the microphone 120 (if available). The comprehension unit 137 analyzes the received data (posture, hand gestures, facial expressions, voice) to determine the user's comprehension level.

The comprehension unit 137 may detect the user anxiety that can further inducing the user to have comprehension issues. The user anxiety can indicate that the user is having a comprehension issue. The comprehension unit 137 detects a user anxiety by analyzing the user facial expression illustrated in the video from the rear camera 116. Furthermore, the user anxiety can be detected by analyzing the received audio data to detect the audio events in the received audio data, such as, tone variations, hesitation, stuttering of the user voice. The comprehension unit 137 can analyze the video data of the user face to track the user eye movements to determine if the user hesitates on a word. If the user eyes hesitate on a word, then the comprehension unit 137 determines that the user is having a comprehension issue. For example, if the user is reading the text and the user eyes pause on a word for a period of time, then the comprehension unit 137 determines the user is having a comprehension issue.

The comprehension unit 137 determines when the user is having a comprehension issue with text based on the user gestures, eye movement, audio data, or other indicators. The comprehension unit 137 identifies the word that is causing the comprehension issue and transmits the word to the translation unit 138. The translation unit 137 retrieves the user native language preference from the user profile 132. The translation unit 137 determines the language of the identified word that is causing the comprehension issue. The translation unit 137 compares the langue of the identified word to the user identified native language to determine if the languages are the same or different. If it is the same language, then the translation unit 137 connects with an outside server 140 that contains a lexicon database 142. The lexicon database 142 is a data store that contains information about language of the text, more specifically, the database stores definition, synonyms, antonyms, and pronunciation of words. The translation unit 138 receives the definition, synonyms, antonyms, and pronunciation from the lexicon database 142 for the word that is causing the comprehension issue for the user. The translation unit 138 utilizes the graphical interface 112 to display the definition, synonyms, antonyms, and pronunciation of the word causing the comprehension issue. The translation unit 138 utilizes different font colors when displaying the definition, synonyms, antonyms, and pronunciation in order to distinguish them from each other. The translation unit 138 can utilize the audio device 122 to play audio data, where the audio data describes the definition, synonyms, antonyms, and the pronunciation of the word causing the comprehension issue.

When the translation unit 138 determines that the language of a word is causing issues is in a different language than the user's native language, then the translation unit 138 first conveys the information about the word in the foreign language. The translation unit 138 conveys the information about the word causing the comprehension issue in the user native language only if comprehension issue remains after the information was conveyed in the foreign language. The information provided by the translation unit 138 at first includes the definition, synonyms, antonyms, and pronunciation of words in the foreign language. The translation unit 138 utilizes the graphical interface 112 to display the definition of the word causing confusion, to display synonyms and to display the antonyms for the work causing confusion. The translation unit 138 first displays the definition, synonyms, antonyms, and pronunciation of the word causing the comprehension issue in the foreign language, i.e. the language of the text that the user is reading. The comprehension unit 137 determines that the user still does not comprehend the word, then the translation unit 138 displays the definition, synonyms, antonyms, and pronunciation of the word causing the comprehension issue in the native language of the user. By displaying the definition, synonyms, antonyms, and pronunciation of the word causing the comprehension issue in the same language as the text (i.e. a foreign language for the user) it allows for the user to gain a better understanding and comprehension of the foreign language. The translation unit 138 utilizes different font colors when displaying the definition, synonyms, antonyms, and pronunciation of the word. The translation unit 138 further uses a different font colors or styles to distinguish between the foreign language and the native language of the user.

The translation unit 138 utilizes the audio device 122 to play audio data, where the audio data describes the definition, synonyms, antonyms, and the pronunciation of the word causing the comprehension issue. The translation unit 138 first uses audio data in the foreign language to provide the definition, synonyms, antonyms, and pronunciation of the word causing the comprehension issue to help the user to gain a better understanding and comprehension of the foreign language. When the comprehension unit 137 still determines that the word is causing a comprehension issue for the user, then the translation unit 138 provides the audio data in the user native language. The goal of the lexicon application 130 is to help to the user in providing selective translation of words. By only providing translation of a few words allows for the user to gain comprehension in the language of the text.

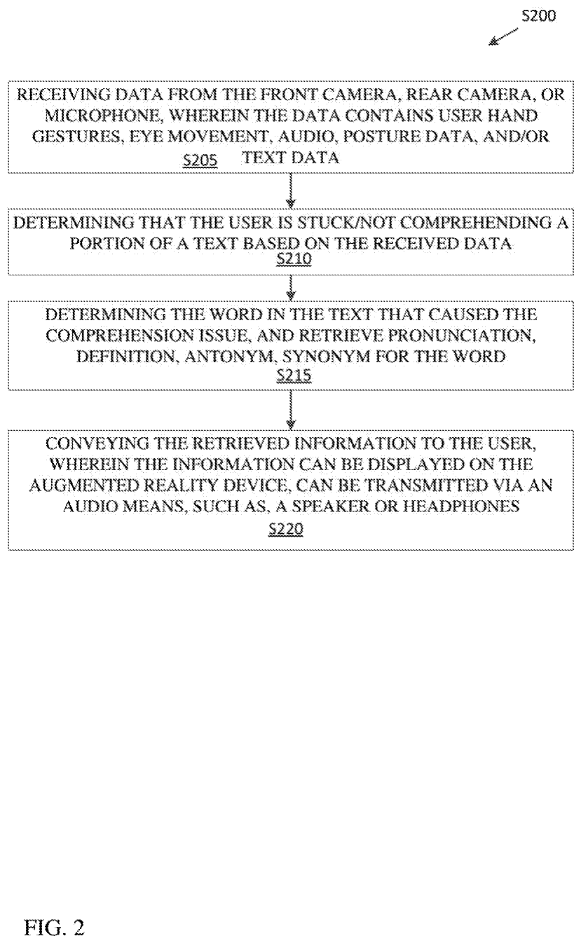

FIG. 2 is a flowchart depicting operational steps 200 of the augmented reality processing environment 100 of FIG. 1, in accordance with an embodiment of the present invention.

The lexicon application 130 receives data from the components of the augmented device 110 (S205). The received data contains data from at least the front camera 114 and the rear camera 116, but the data could also contain data from the biometric sensor 118 and/or microphone 120 (S205). The data from the front camera 114 contains images of the text the user is reading, and the data can contain images of user made hand gestures. The data from the rear camera 116 contains images of the user face, which capture the user's facial expressions and captures the user's eye movement. The data from the biometric sensor 118 contains data related to the biometrics of the user. The data from the microphone 120 is audio data from the user, such as, the user reading the text, stuttering over the text, hesitating over the text, and the tone of the user.

The gesture unit 136 analyzes the data from the front camera 114 to determine if the user makes any gestures in the field of view of the front camera 114 (S210). For example, the user could point (i.e. a gesture) to a word on the text that he is reading to signal that the user does not comprehend a word. The comprehension unit 137 receives the data from the rear camera 116, the biometric sensor 118, and/or microphone 120 to determine if the user has a comprehension issue with the text he is reading (S210). For example, the user's eye movement could indicate he is having a comprehension issue based on if the user eye movement stops on a word. For example, the comprehension unit 137 analyzes the user facial expressions to determine if the user is having a comprehension issue. Furthermore, when the comprehension unit 137 receives audio data from the microphone 120, where the audio data includes user stuttering, hesitation as the user is reading, the user stating he does not know a word, etc. This allows for the comprehension unit 137 to determine that the user is having a comprehension issue based on the audio data (S210).

The comprehension unit 137 determines the word in the text that is causing the user comprehension issue from the user gestures, eye movement, facial expressions, audio, etc., and send that word to the translation unit 138 (S215). The translation unit 138 retrieves the user native language from a user profile 134 and determines if the language of the text is in a foreign language for the user or in the user native language. The translation unit 138 retrieves the definition, synonyms, antonyms, and pronunciation for the word causing confusion in the user native language and the foreign language (if the text is a foreign language) from a lexicon database 142 located on a server 140 (S215).

The language of the text the user is reading (e.g. native language or foreign language) determines how the translation unit 138 provides the information to the user. When the text is a foreign language, then the translation unit 138 first utilizes the graphical interface 112 of the augmented device 110 to display the definition, synonyms, antonyms, and pronunciation for the word causing the comprehension issue in the foreign language (S220). By first displaying the definition, synonyms, antonyms, and pronunciation for the word causing the comprehension issue in the foreign language allow for the user to gain a better comprehension of the foreign language. The definition, synonyms, antonyms, and pronunciation are displayed using different font colors to distinguish them for each other. When the comprehension unit 137 determines that the word in the text is still causing the user comprehension issues after the definition, synonyms, antonyms, and pronunciation were displayed in the foreign language, then the translation unit 138 displays on the graphical interface 112 the definition, synonyms, antonyms, and pronunciation in the user native language (S220). When an audio device 122, such as, a speaker, headphones, or another audio device, is attached to the augmented device 110, then the translation unit 138 conveys the definition, synonyms, antonyms, and pronunciation of the word through audio device 122 (S220). The foreign language is first used by the translation unit 138 to convey the definition, synonyms, antonyms, and pronunciation of the audio file to provide the user more exposure to the foreign language (S220). When the comprehension unit 137 determines that the word in the text is still causing the user comprehension issues then the translation unit 138 utilizes the user native language to convey the definition, synonyms, antonyms, and pronunciation of the audio file (S220).

FIG. 3 depicts a block diagram of components of the augmented device 110 and the sever 140 in the augmented reality processing environment 100 of FIG. 1 of FIG. 1, in accordance with an embodiment of the present invention. It should be appreciated that FIG. 3 provides only an illustration of one implementation and does not imply any limitations regarding the environments in which different embodiments may be implemented. Many modifications to the depicted environment may be made.

Augmented device 110 and server 140 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications, and network processors, etc.), system memory, peripheral devices, and any other hardware components within a system.

One or more operating systems 910, and one or more application programs 911, for example, lexicon application 130 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information. Augmented device 110 and server 140 may also include a R/W drive or interface 914 to read from and write to one or more portable computer readable storage media 926. Application programs 911 on the augmented device 110 and server 140 may be stored on one or more of the portable computer readable storage media 926, read via the respective R/W drive or interface 914 and loaded into the respective computer readable storage media 908. Augmented device 110 and server 140 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the augmented device 110 and server 140 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers. Augmented device 110 and server 140 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and lexicon application 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method for providing a selective translation of a word when the user is utilizing an augmented reality device to read text, the method comprising:
receiving, by the computer, data from an augment reality device, wherein the data at least includes a first video of where the augmented device is pointed, wherein the first video at least includes images of a text a user is reading, wherein the data further includes a second video of the user face as the user is reading the text;
evaluating, by the computer, the data to determine that the user is having a comprehension issue with a word on the text;
retrieving, by the computer, a definition of the word, synonyms of the word, antonyms of the word, and the pronunciation of the word that is causing the comprehension issue; and
conveying, by the computer, the definition of the word, synonyms of the word, antonyms of the word, and the pronunciation of the word that is causing the comprehension issue to the user.

2. The method of claim 1, wherein conveying, by the computer, the definition of the word, synonyms of the word, antonyms of the word, and the pronunciation of the word that is causing the comprehension issue to the user further comprises:
displaying, by the computer, the definition of the word, synonyms of the word, antonyms of the word, and the pronunciation of the word that is causing the comprehension issue.

3. The method of claim 2, wherein the definition of the word, synonyms of the word, antonyms of the word, and the pronunciation of the word are displayed in different colors.

4. The method of claim 1, wherein conveying, by the computer, the definition of the word, synonyms of the word, antonyms of the word, and the pronunciation of the word that is causing the comprehension issue to the user further comprises:
playing, by the computer, an audio file that contains definition of the word, synonyms of the word, antonyms of the word, and the pronunciation of the word.

5. The method of claim 1, further comprising:
determining, by the computer, a language of the text in the first video;
retrieving, by the computer, a native language of the user from a user profile; and
wherein the language of the text and the native language of the user are different.

6. The method of claim 5, wherein conveying, by the computer, the definition of the word, synonyms of the word, antonyms of the word, and the pronunciation of the word that is causing the comprehension issue to the user further comprises:
displaying, by the computer, the definition of the word, synonyms of the word, antonyms of the word, and the pronunciation of the word that is causing the comprehension issue, wherein the definition of the word, synonyms of the word, antonyms of the word, and the pronunciation of the word are displayed using the language of the text.

7. The method of claim 6, further comprising:
receiving, by the computer, a second set data from an augment device, wherein the second set of data includes data similar to what previously received;
evaluating, by the computer, the second set of data to determine that the user is still having a comprehension issue with the word on the text; and
displaying, by the computer, the definition of the word, synonyms of the word, antonyms of the word, and the pronunciation of the word that is causing the comprehension issue, wherein the definition of the word, synonyms of the word, antonyms of the word, and the pronunciation of the word are displayed using the native language of the user.

8. The method of claim 5, wherein conveying, by the computer, the definition of the word, synonyms of the word, antonyms of the word, and the pronunciation of the word that is causing the comprehension issue to the user further comprises:
playing, by the computer, an audio file that contains definition of the word, synonyms of the word, antonyms of the word, and the pronunciation of the word, wherein the audio file is in the same language as the text.

9. A computer program product for a selective translation of a word when the user is utilizing an augmented reality device to read text, the computer program product comprising:
one or more non-transitory computer-readable storage media and program instructions stored on the one or more non-transitory computer-readable storage media, the program instructions comprising:
program instructions to receive data from an augment reality device, wherein the data at least includes a first video of where the augmented device is pointed, wherein the first video at least includes images of a text a user is reading, wherein the data further includes a second video of the user face as the user is reading the text;
program instructions to evaluate the data to determine that the user is having a comprehension issue with a word on the text;
program instructions to retrieve a definition of the word, synonyms of the word, antonyms of the word, and the pronunciation of the word that is causing the comprehension issue; and
program instructions to convey the definition of the word, synonyms of the word, antonyms of the word, and the pronunciation of the word that is causing the comprehension issue to the user.

10. The computer program product of claim 9, wherein conveying the definition of the word, synonyms of the word, antonyms of the word, and the pronunciation of the word that is causing the comprehension issue to the user further comprises:
program instructions to display the definition of the word, synonyms of the word, antonyms of the word, and the pronunciation of the word that is causing the comprehension issue.

11. The computer program product of claim 10, wherein the definition of the word, synonyms of the word, antonyms of the word, and the pronunciation of the word are displayed in different colors.

12. The computer program product of claim 9, wherein conveying the definition of the word, synonyms of the word, antonyms of the word, and the pronunciation of the word that is causing the comprehension issue to the user further comprises:
program instructions to playing an audio file that contains definition of the word, synonyms of the word, antonyms of the word, and the pronunciation of the word.

13. The computer program product of claim 9, further comprising:
program instructions to determine a language of the text in the first video;
program instructions to retrieve a native language of the user from a user profile; and
wherein the language of the text and the native language of the user are different.

14. The computer program product of claim 13, wherein conveying the definition of the word, synonyms of the word, antonyms of the word, and the pronunciation of the word that is causing the comprehension issue to the user further comprises:
program instructions to display the definition of the word, synonyms of the word, antonyms of the word, and the pronunciation of the word that is causing the comprehension issue, wherein the definition of the word, synonyms of the word, antonyms of the word, and the pronunciation of the word are displayed using the language of the text.

15. The computer program product of claim 14, further comprising:
program instructions to receive a second set data from an augment device, wherein the second set of data includes data similar to what previously received;
evaluating, by the computer, the second set of data to determine that the user is still having a comprehension issue with the word on the text; and
program instructions to displaying the definition of the word, synonyms of the word, antonyms of the word, and the pronunciation of the word that is causing the comprehension issue, wherein the definition of the word, synonyms of the word, antonyms of the word, and the pronunciation of the word are displayed using the native language of the user.

16. The computer program product of claim 13, wherein conveying, by the computer, the definition of the word, synonyms of the word, antonyms of the word, and the pronunciation of the word that is causing the comprehension issue to the user further comprises:
program instructions to play an audio file that contains definition of the word, synonyms of the word, antonyms of the word, and the pronunciation of the word, wherein the audio file is in the same language as the text.

17. A computer system for a selective translation of a word when the user is utilizing an augmented reality device to read text, the computer system comprising:
one or more computer processors, one or more computer-readable storage media, and program instructions stored on one or more of the computer-readable storage media for execution by at least one of the one or more processors, the program instructions comprising:
program instructions to receive data from an augment reality device, wherein the data at least includes a first video of where the augmented device is pointed, wherein the first video at least includes images of a text a user is reading, wherein the data further includes a second video of the user face as the user is reading the text;
program instructions to evaluate the data to determine that the user is having a comprehension issue with a word on the text;
program instructions to retrieve a definition of the word, synonyms of the word, antonyms of the word, and the pronunciation of the word that is causing the comprehension issue; and
program instructions to convey the definition of the word, synonyms of the word, antonyms of the word, and the pronunciation of the word that is causing the comprehension issue to the user.

18. The computer system of claim 17, further comprising:
program instructions to determine a language of the text in the first video;
program instructions to retrieve a native language of the user from a user profile; and
wherein the language of the text and the native language of the user are different.

19. The computer system of claim 18, wherein conveying the definition of the word, synonyms of the word, antonyms of the word, and the pronunciation of the word that is causing the comprehension issue to the user further comprises:
program instructions to display the definition of the word, synonyms of the word, antonyms of the word, and the pronunciation of the word that is causing the comprehension issue, wherein the definition of the word, synonyms of the word, antonyms of the word, and the pronunciation of the word are displayed using the language of the text.

20. The computer system of claim 19, further comprising:
program instructions to receive a second set data from an augment device, wherein the second set of data includes data similar to what previously received;
evaluating, by the computer, the second set of data to determine that the user is still having a comprehension issue with the word on the text; and
program instructions to displaying the definition of the word, synonyms of the word, antonyms of the word, and the pronunciation of the word that is causing the comprehension issue, wherein the definition of the word, synonyms of the word, antonyms of the word, and the pronunciation of the word are displayed using the native language of the user.
